(19) United States
(12) Patent Application Publication
(10) Pub. No.: US 2022/0384872 A1
(43) Pub. Date: Dec. 1, 2022

(54) BATTERY MODULE FOR A TRACTION BATTERY OF AN ELECTRIC VEHICLE, TRACTION BATTERY FOR AN ELECTRIC VEHICLE, AND METHOD OF MANUFACTURING SUCH A TRACTION BATTERY

(71) Applicant: Lisa Draeximaier GmbH, Vilsbiburg (DE)

(72) Inventors: Peter Wagner, Karlsfeld (DE); Benjamin Bardosch, Landshut (DE); Michael Flieser, Geisenhausen (DE); Alexander Hahn, Roettenbach (DE); Robert Magunia, Geisenhausen (DE); Thomas Sperl, Laudau an der Isar (DE)

(21) Appl. No.: 17/750,443

(22) Filed: May 23, 2022

(30) Foreign Application Priority Data
May 25, 2021 (DE) 10 2021 113 416.1

(51) Int. Cl. H01M 10/653; H01M 10/058; H01M 10/625; H01M 10/647; H01M 10/6551; H01M 10/6554; H01M 10/6556

(52) U.S. Cl. CPC H01M 10/653; H01M 10/058; H01M 10/625; H01M 10/647; H01M 10/6551; H01M 10/6554; H01M 10/6556; H01M 10/052

(57) ABSTRACT

A battery module for a traction battery of an electric vehicle is disclosed. The battery module includes a heat transfer surface for tempering cells of the battery module and at least one cavity disposed between partial surfaces of the heat transfer surface for receiving excess heat conductive material.

### CROSS REFERENCE TO RELATED APPLICATIONS

This application claims priority to German patent application 10 2021 113 416.1, filed May 25, 2021, the content of which is herein incorporated by reference.

### BACKGROUND OF THE INVENTION

### Field of the Invention

The present invention relates to a battery module for a traction battery of an electric vehicle, a traction battery comprising at least one such battery module, and a method of manufacturing such a traction battery.

### Description of Related Art

The present invention is described below mainly in connection with traction batteries for electric vehicles. However, the invention can be used in any accumulator in which large amounts of heat are to be added or removed.

A traction battery of an electric vehicle is configured to store electrical energy for driving the electric vehicle with automotive high-voltage, to be discharged during operation of acceleration processes with high amperages and to be charged via electrical braking processes with high amperages. The high currents create thermal losses that must be dissipated as heat to maintain a temperature of the traction battery within a designated operating range. For this purpose, the traction battery can have a temperature control device. For example, a fluid may be used in the temperature control device to remove the heat. The temperature control device can also supply heat to the traction battery when the temperature is below the operating range.

The temperature control unit can be designed as a cooling plate, for example. Heat transfer surfaces of traction battery modules can be thermally coupled to the temperature control unit using gap filler, a paste-like heat transfer material. The gap filler is metered between the heat transfer surfaces and the temperature control device. The battery modules are pressed into the gap filler. The gap filler is distributed between the heat transfer surfaces and the temperature control unit. Voids or gaps between the temperature control unit and the heat transfer surfaces are filled. An actual contact area between the temperature control unit and the battery modules is maximized. The gap filler cross-links after impression but can retain elastic properties even in the cured state. The gap filler can also retain its paste-like property.

### BRIEF DESCRIPTION OF THE INVENTION

One task of the invention is therefore to provide an improved battery module for a traction battery of an electric vehicle, an improved traction battery with at least one such battery module and an improved method for producing such a traction battery, using means that are as simple as possible in terms of design. An improvement in this respect may relate, for example, to a reduced setting force during bead breaking.

Pasty heat-conducting material can be referred to as gap filler. In its processable state, the heat-conducting material has a paste-like consistency due to a high content of ceramic particles in particular. Without externally applied pressure on the pasty heat-conducting material, the heat-conducting material does not drip or flow. When pressure is applied, the heat-conducting material yields and flows in the direction of a lower pressure. Due to the paste-like consistency, a flow resistance of the thermal conductive material increases strongly with decreasing layer thickness. A high static pressure acting on the surfaces can occur between two surfaces. The pressure can deform the surfaces. The larger the contiguous contact area between the surfaces, the greater the pressure can be.

In the approach presented here, at least one of the surfaces involved is divided into partial surfaces, between which cavities are arranged. The cavities thus interrupt the continuous contact surface and thus enable short flow distances of the heat-conducting material. The short flow distances allow the static pressure to be limited. Excess heat-conducting material can flow off into the cavities.

A battery module for a traction battery of an electric vehicle is proposed, wherein the battery module comprises a heat transfer surface for tempering cells of the battery module and at least one cavity arranged between partial surfaces of the heat transfer surface for receiving excess heat conducting material pasty during processing. The battery module may comprise one or more cells.

Furthermore, a traction battery for an electric vehicle is proposed, the traction battery comprising a temperature control device and at least one battery module according to the approach proposed herein, wherein the battery module is thermally coupled to the temperature control device using a thermal conductive material pasty during processing, wherein excess thermal conductive material is displaced from a contact region between the partial surfaces of the heat transfer surface of the battery module and the temperature control device into the at least one cavity of the battery module.

Furthermore, a method for manufacturing a traction battery according to the approach presented herein is proposed, wherein pasty heat conductive material is metered into a contact area between partial surfaces of a heat transfer surface of at least one battery module according to the approach presented herein and a tempering device, wherein the heat transfer surface is placed onto the tempering device and pressed against the tempering device with a setting force, wherein the heat conductive material is at least partially displaced from the contact area into the at least one cavity of the battery module.

A traction battery can be understood as an energy storage device for an electrically driven vehicle. The traction battery can have a housing that encloses components of the traction battery and protects them from mechanical influences and environmental influences. The housing may have internal stiffening elements. The traction battery may have a modular design. The traction battery can be attached to a floor assembly of the vehicle, for example.

A temperature control unit can be part of the housing. In particular, the temperature control unit can be integrated into a base of the traction battery. The temperature control device may be referred to as a cooling plate. The temperature control device may be a heat exchanger for supplying and removing thermal energy. The temperature control device may include a fluid for heat transport. In particular, the temperature control device may include a heat transport fluid. The temperature control device can be supplied by an air conditioning system of the vehicle.

The traction battery can have several battery modules. The battery modules can be arranged between the stiffening elements of the traction battery. A battery module can combine several cells or battery cells. The cells may be electrically interconnected within the battery module. The battery module can also have a housing that encloses the cells. The battery modules can be electrically interconnected within the traction battery.

The battery module may have at least one heat transfer surface that is thermally coupled to the cells. The heat transfer surface can in particular be a bottom surface of the battery module. For example, the heat transfer surface can be coupled to the cells via heat conducting plates arranged between the cells. The heat transfer surface is thermally coupled to the temperature control device during the manufacture of the traction battery using paste-like heat conductive material. The thermally conductive material is processed in the pasty or paste-like state and can crosslink or cure after processing. The pasty thermal conductive material may be referred to as a gap filler. The pasty thermal conductive material may have a low thermal resistance. The thermal conductive material may be electrically insulating. The thermal conductive material may have a ceramic filler. The pasty thermal conductive material may have fluid-like properties under the effect of pressure, i.e. it may be flowable.

During the production of the traction battery, the paste-like heat-conducting material is metered onto the heat transfer surface and/or the temperature control unit in a contact area. The heat transfer surface is then placed on the temperature control unit and pressed into the thermally conductive material with a setting force. The heat-conducting material located between the heat transfer surface and the temperature control unit can be at least partially displaced laterally. As it flows, the heat-conducting material compensates for manufacturing tolerances of the battery module and the temperature control unit. Furthermore, the heat-conducting material fills a cavity of the heat transfer surface and a surface of the temperature control unit. As a result, the heat transfer surface can be in full-surface contact with the heat conducting material. The heat-conducting material can in turn be in full-surface contact with the temperature control device. Excess heat-conducting material swells laterally out of the contact area.

In the approach presented here, the heat transfer surface is divided into at least two partial surfaces. The contact area is thus also subdivided. Between the partial surfaces, the battery module has at least one cavity. A cavity may be referred to as a cavity or recess. The cavity may be a recess in the heat transfer surface. A width of the cavity may be smaller than widths of adjacent partial surfaces of the heat transfer surface. A depth of the cavity may be less than, equal to, or greater than the width of the cavity. The cavity allows for shortened flow paths for the displaced heat transfer material. The excess heat transfer material can be displaced out of the contact area and into the cavity. The shortened flow path allows the settling force to be reduced. Thus, a reduced static pressure builds up between the heat transfer surface and the temperature control device, and deformation of the temperature control device can be prevented. After the battery module has been pressed against the temperature control unit, the heat-conducting material can cure. The cured heat conducting material can remain flexible.

The battery module can also have several cavities. The cavities can be arranged regularly, in particular equidistantly, across the heat transfer surface. For example, the cavities may each be spaced up to 80 millimeters apart. In other words, the cavities may be arranged distributed along the heat transfer surface in such a way that a maximum lateral distance between next adjacent cavities is less than or equal to 80 mm, preferably less than or equal to 50 mm, preferably less than or equal to 35 mm. This results in a maximum flow path of 25 millimeters to the nearest cavity.

At least one cavity can be formed as a pocket in the heat transfer surface. A pocket can be a local recess, in particular a recess limited in two mutually transverse directions. Lateral dimensions of the pockets may be smaller than distances between next adjacent pockets, for example. The partial surfaces may surround the at least one cavity. The heat transfer surface may be formed as a continuous heat transfer sheet. The heat transfer plate may be three-dimensionally deformed in the region of the cavity.

Alternatively, at least one cavity may be arranged between every two ribs of the heat transfer surface. The partial surfaces of the heat transfer surface may be arranged on the ribs. The cavity may be a channel between the ribs. The channel may extend to a boundary of the heat transfer surface. Through the channel, trapped air can easily escape laterally when the battery module is placed on the temperature control device. When pressing with the setting force, the excess heat conducting material can then escape laterally through the channel

The partial surfaces may be formed by end portions, located outside gaps between the cells, of heat conducting sheets of the battery module located in the gaps. A heat conducting plate may be substantially flat/planar. One cell may abut each side of the heat baffle. The cells may be Li-ion cells, for example. The cells may have different designs. In particular, the cells may be pouch cells or prismatic cells.

The end regions can be bent transversely to a main extension plane of the heat conducting sheets. This allows the heat transfer surface to be oriented substantially perpendicular to the heat baffles. An end region may be substantially as wide as one of the cells adjacent to the heat baffle.

The end areas can be slotted. The end areas can be divided into many partial areas. Slits can be used to press each partial area individually into the heat-conducting material. The partial surface can deform elastically and/or plastically in accordance with the static pressure that is applied. In other words, the partial surfaces can adapt to a contour of the tempering device.

Two adjacent end regions can each form a rib. In particular, the end regions can be bent towards each other. For example, one end region may be 20 millimeters wide. The resulting rib can be 50 millimeters wide or less, for example, since the end regions do not touch in the middle of the rib.

The partial surfaces may be oriented at an acute angle, for example an angle of less than 70°, preferably less than 50° or less than 30°, to a reference plane of the heat transfer surface. In particular, the partial surfaces may be oriented at an angle in the direction of the cavity. The acute angle can be used to specify a flow direction of the heat transfer material. When the acute angle is in the direction of the cavity, the excess heat transfer material flows in the direction of the cavity. A clear flow direction can prevent air pockets. The acute angle additionally reduces the flow resistance of the heat-conducting material.

### BRIEF DESCRIPTION OF THE SEVERAL VIEWS OF THE DRAWING

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

An advantageous embodiment of the present invention is set out below with reference to the accompanying figures, wherein:

FIG. 1 depicts a representation of a battery module according to an embodiment example; and

FIG. 2 depicts a sectional view of a traction battery according to an embodiment.

The figures are merely schematic representations and serve only to explain the invention. Identical or similarly acting elements are marked throughout with the same reference signs.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C.

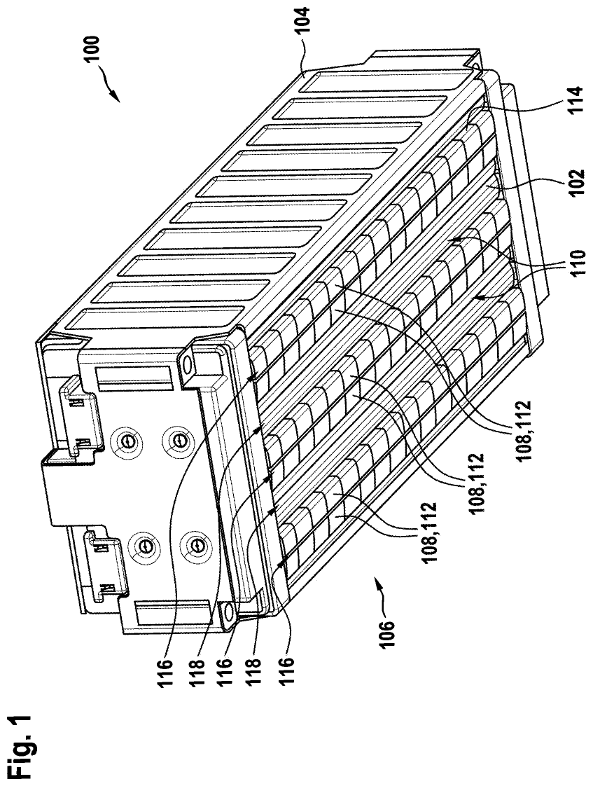

FIG. 1 depicts an illustration of a battery module 100 according to an embodiment. Several such battery modules 100 can be connected in parallel and/or in series in a traction battery of an electric vehicle. For this purpose, the individual battery modules 100 are inserted into a housing or frame of the traction battery and electrically connected to one another. For tempering the battery modules 100, the traction battery has a tempering device, which can be arranged in a bottom of the housing, for example, or can form the bottom of the traction battery. The battery modules 100 are thermally coupled to the temperature control device using a thermal conductive material. In particular, the temperature control device may be used to cool the battery modules 100. At low temperatures, the temperature control device may also be used to heat the battery modules 100.

The battery module 100 includes a plurality of pouch cells or prismatic cells 102. The cells 102 are arranged flat side to flat side, side by side, within a housing 104 of the battery module 100. The flat sides of the cells 102 are oriented perpendicular to a heat transfer surface 106 of the battery module 100. The heat transfer surface 106 is thus arranged here at a bottom of the housing 104. The battery module can be coupled to the temperature control device of the traction battery via the heat transfer surface 106.

Alternatively, the cells 102 may be stacked horizontally on top of each other. In that case, the battery module 100 may have at least one lateral heat transfer surface 106. Depending on the design of the temperature control device, the battery module 100 may also have multiple heat transfer surfaces 106.

In the approach presented herein, the heat transfer surface 106 is divided into a plurality of sub-surfaces 108. The partial surfaces 108 define a contact area to the temperature control device. Cavities 110 are disposed between the partial surfaces 108. The cavities 110 are recesses behind a main extension plane of the heat transfer surface 106. The cavities 110 interrupt the contact area. The cavities 110 are configured to receive excess heat transfer material during assembly of the traction battery, which is disposed between the partial surfaces 108 and the temperature control device to thermally connect the battery module 100 to the temperature control device.

The thermally conductive material is pasty at least during assembly of the traction battery, completely filling a gap between the partial surfaces 108 and a surface of the temperature control device when the battery module 100 is placed on the temperature control device and pressed against the temperature control device with a setting force. Upon pressing, the paste flows along the gap and excess heat conductive material can swell out of the gap into the adjacent cavity.

The heat transfer surface 106, which is divided into the partial surfaces 108, results in short flow paths to the next cavity 110. Due to the short flow paths, only a low pressure builds up within the pasty heat transfer material between the temperature control unit and the partial surfaces 108 when the battery module 100 is pressed against the temperature control unit. Due to the low pressure, a low setting force is required to press the battery module 100. The tempering device is subjected to only a small amount of stress due to the low setting force.

Here, the housing 104 is open at the heat transfer surface 106 and the partial surfaces 108 are formed by bent end portions 112 of heat baffles 114 disposed between the cells 102. Here, the heat baffles 114 are disposed between every other cell 102 and the end portions 112 of adjacent heat baffles 114 are bent in opposite directions. As a result, two each of the end portions 112 projecting between the cells form ribs 116 between which cavities 110 are disposed. The cells 102 are exposed in the cavities 110. The cavities 110 form channels 118 between the ribs 116. The channels 118 extend to the edge of the heat transfer surface 106. Air trapped between the battery module 100 and the temperature control device can escape laterally through the channels 118.

In an alternative embodiment, the housing 104 is closed at the heat transfer surface 106 and the heat transfer surface 106 is a continuous side of the housing 104. The partial surfaces 108 are contiguous and the cavities 110 are formed as recesses in the heat transfer surface 106. The depressions may be referred to as pockets.

In one embodiment, the end regions 112 of the heat conducting sheets 114 are slotted. As a result, each end region 112 forms a plurality of partial surfaces 108. The individual sub-surfaces 108 can thus deform individually during press-off without affecting the adjacent sub-surfaces 108.

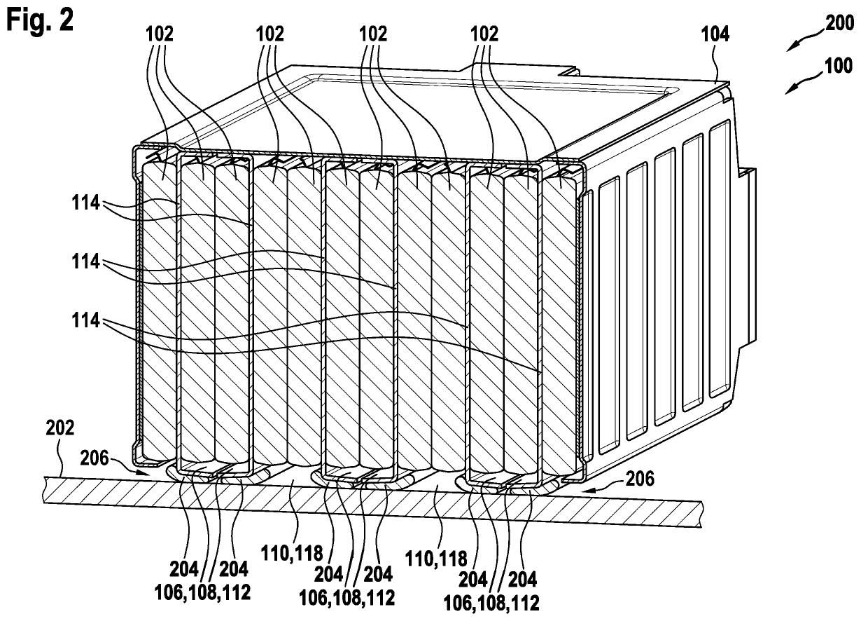

FIG. 2 shows a sectional view of a section of a traction battery 200 according to an embodiment. The traction battery 200 has a temperature control device 202 and at least one battery module 100. The battery module 100 is substantially the same as the battery module in FIG. 1. The battery module 100 is thermally coupled to the temperature control device 202 using thermal conductive material 204. The thermally conductive material 204 bridges gaps 206 between the sub-surfaces 108 of the heat transfer surface 106 and the temperature control device 202. Excess thermally conductive material 204 has been displaced laterally from the gaps 206 into the cavities 110 located between the sub-surfaces 108.

In one embodiment, the partial surfaces 108 are oriented at a slight angle to the surface of the temperature control device 202. As a result, the gaps 206 taper from the adjacent cavity 110 to an acute angle. The acute angle of the gaps 206 has facilitated lateral displacement of the thermally conductive material 204 into the cavities 110, as the widest point of the gaps 206 is directly adjacent to the respective cavity 110.

In other words, a flow path optimized bottom structure of a battery module is presented.

When placing cell modules in a battery housing, a gap filler is used for homogeneous thermal connection to a cooling area (e.g. cooling plate). This paste-like material is applied to the connection surface and then compressed when the modules are placed. To ensure that the gap filler can flow evenly and the excess can be displaced to the side edges of the module, the modules have so far been inserted into the battery frame with very high setting forces, which can lead to deformation or undesirable deformation of the components. For this reason, additional mounting aids have so far been used to counteract the setting forces. Furthermore, a long holding force has been necessary up to now so that the gap filler can overcome the long flow distances.

In the approach presented here, cavities are provided on the thermal contact surface which can absorb excess gap filler during setting, thus enabling very short flow paths and greatly reducing the setting forces. Furthermore, the short flow paths allow faster setting and thus shorter cycle times.

The cell module presented here has cavities on the thermal bonding surface into which the gap filler is partially displaced during placement. The cavities can be formed by a rib structure. Alternatively, the cavities may be formed as pockets. The cavities can be arranged in such a way that the flow path of the gap filler is reduced to at most 50 mm. In particular, the cavities may be arranged such that the flow path of the gap filler is reduced to at most 20 mm. The cell module may comprise pouch cells or prismatic cells. The cells may be lithium cells for a vehicle. The bottom structure can be formed by the heat conducting sheets.

Since the devices and methods described in detail above are examples of embodiments, they can be modified to a wide extent by the skilled person in the usual manner without leaving the scope of the invention. In particular, the mechanical arrangements and the proportions of the individual elements with respect to each other are merely exemplary. Some preferred embodiments of apparatus according to the invention have been disclosed above. The invention is not limited to the solutions explained above, but the innovative solutions can be applied in different ways within the limits set by the claims.

What is claimed is:

1. A battery module for a traction battery of an electric vehicle, the battery module comprising:
at least one heat transfer surface configured to temper cells of the battery module; and
at least one cavity arranged between partial surfaces of the heat transfer surface and configured to receive excess heat conducting material.

2. The battery module according to claim 1, wherein the cavity is a pocket in the heat transfer surface and the sub-surfaces surround the cavity.

3. The battery module according to claim 1, wherein the cavity is arranged between two fins of the heat transfer surface, and the sub-surfaces are disposed on the fins.

4. The battery module according to claim 1, wherein the partial surfaces are formed by end portions, disposed outside gaps between the cells, of heat conducting sheets of the battery module disposed in the gaps.

5. The battery module according to claim 4, wherein the end portions are bent transversely to a main extension plane of the heat conducting sheets.

6. The battery module according to claim 4, wherein the end portions are slotted.

7. The battery module according to claim 4, wherein each two adjacent end portions form a rib.

8. The battery module according to claim 1, wherein the sub-surfaces are oriented at an acute angle to a reference plane of the heat transfer surface.

9. A traction battery for an electric vehicle, the traction battery comprising:
a temperature control device;
at least one battery module comprising at least one heat transfer surface configured to temper cells of the battery module and at least one cavity arranged between partial surfaces of the heat transfer surface and configured to receive excess heat conducting material;
wherein the battery module is thermally coupled to the temperature control device using a heat conductive material, and
wherein excess thermally conductive material is displaced from a contact region between the partial surfaces of the heat transfer surface of the battery module and the temperature control device into the at least one cavity of the battery module.

10. A method of manufacturing a traction battery, comprising the steps of:
arranging a temperature control device in the traction battery;
arranging at least one battery module in the traction battery, the traction battery comprising at least one heat transfer surface configured to temper cells of the battery module and at least one cavity arranged between partial surfaces of the heat transfer surface and configured to receive excess heat conducting material;
metering pasty heat conductive material into a contact area between partial surfaces of a heat transfer surface of at least one battery module and a temperature control device,
placing the heat transfer surface on the temperature control device and pressing the temperature control device with a setting force,
wherein the battery module is thermally coupled to the temperature control device using a heat conductive material,
wherein excess thermally conductive material is displaced from a contact region between the partial surfaces of the heat transfer surface of the battery module and the temperature control device into the at least one cavity of the battery module, and
wherein the heat conductive material is at least partially displaced from the contact area into the at least one cavity of the battery module.
